(19) United States
(12) Patent Application Publication
(10) Pub. No.: US 2002/0041409 A1
(43) Pub. Date: Apr. 11, 2002

(54) Maintenance system and method for an optical switch fabric

(76) Inventors: Mohammad Laham, Basking Ridge, NJ (US); Raj Acharya, Ocean, NJ (US); Roman Antosik, Colts Neck, NJ (US); Jayanta Das, Morganville, NJ (US); Khem Gandhi, Marlboro, NJ (US); Bharat Dave, Howell, NJ (US); Jithamithra Sarathy, Atlantic Highlands, NJ (US); Ronald Simprini, Red Bank, NJ (US); Chinnabbu Ekambaram, Freehold, NJ (US); Frank Hujber, Mercerville, NJ (US); Boris Stefanov, Gillette, NJ (US); Frederick Renner, West Long Branch, NJ (US); Tan B. Thai, Jackson, NJ (US); Ravi Vora, Freehold, NJ (US)

Correspondence Address: KAPLAN & GILMAN , L.L.P., 900NROUTE 9 NORTH, WOODBRIDGE, NJ, 07095, US

(21) Appl. No.: 09/884,369

(22) Filed: Jun. 19, 2001

Related U.S. Application Data
(60) Provisional application No. 60/238,363, filed on Oct. 6, 2000.

(51) Int. Cl. H04B 10/08; H04J 14/00

(52) U.S. Cl. 359/110; 359/117

(57) ABSTRACT

In a maintenance system for a switch fabric in an optical switching network, a test signal is generated and multiplexed with the incoming traffic signal to form a composite signal. The composite signal is transmitted through the switch fabric via the traffic channel and then demultiplexed back into the traffic signal and the test signal, both of which are monitored by one or optical performance monitors. Thus, if the traffic signal is found to be defective, it is easy to determine whether the cause is the switch fabric or the incoming optical traffic signal that was already bad before entering the switch fabric.

### TECHNICAL FIELD

This invention relates to optical networks, and more particularly, to a maintenance system and method for an optical switch fabric in an optical switching network which may determine whether the internal transmitting channels of the optical switch fabric work properly.

### BACKGROUND OF THE INVENTION

Today, because of their high bandwidth of up to 40 Gb/s, optical fibers are advantageously adopted as core/backbone networks for carrying large amounts of data such as voice telephony and multimedia data. As these optical fiber pipes traverse the optical switching network systems, signal degradation and/or total disruption may happen. Once one of these faults is detected by maintenance circuitry internal to the network nodes through which the signals pass, it is often a formidable and time-consuming task to identify the cause of the problem. Fault recovery mechanisms in a maintenance system need to determine if the signal was already bad before entering the node, or if it was compromised by internal nodal faults of the optical switch fabric in the optical switching network system. Traditionally, this has involved complex software algorithms that try to identify the most probable failure causes among a host of possibilities.

Therefore, it is an object of the invention to provide a maintenance system for an optical switch fabric that is capable of easily and reliably identifying between the above two fault causes without using complex algorithms.

It is another object of the invention to provide a maintenance method for an optical switch fabric that is capable of easily determining whether a fault of traffic signal is caused by the switch fabric.

### SUMMARY OF THE INVENTION

In a first aspect of the invention, a maintenance system for an optical switch fabric comprises a generator for generating a test signal, a multiplexer for optically multiplexing the test signal with the incoming optical traffic signal to form a composite signal which is transmitted through the switch fabric via the traffic channel, a demultiplexer for optically demultiplexing the composite signal outcome from the switch fabric into the test signal and the traffic signal, and means for measuring the quality of both the demultiplexed test and traffic signals. Thus, it can be easily determined from the measurement results that the cause of a fault, if any, is the incoming traffic signal itself or the switch fabric. In other words, if both the demultiplexed test and traffic signals are found to be defective, the switch fabric is deemed the fault cause, and if only the demultiplexed traffic signal is found to be defective, then it can be determined that the traffic signal was already bad before entering the switch fabric.

In a second aspect of the invention, a method of maintenance for an optical switch fabric comprising the steps of generating a test signal, multiplexing the signal with the incoming optical traffic signal to form a composite signal, transmitting the composite signal through the switch fabric via the traffic channel, demultiplexing the composite signal into the test and traffic signal, and measuring the quality of both the demultiplexed test and traffic signals to determine the fault cause.

In a preferred embodiment, the maintenance system can shift between a background maintenance mode and a real-time maintenance mode. In the background maintenance mode, the test signal is transmitted through the switch fabric via a selected test channel, and its quality is measured by the optical performance monitor so as to determine whether the test channel works properly. In the real-time maintenance mode, the test signal is multiplexed with the incoming traffic signal and the composite signal is transmitted through the switch fabric via the traffic channel. The composite signal output from the switch fabric is demultiplexed back into the test signal and traffic signals. The quality of the demultiplexed traffic and test signals is measured so as to determine whether the traffic channel works properly.

Preferably, the maintenance system usually operates in the background mode and shifts to the real-time mode when a traffic signal is found to be defective.

### BRIEF DESCRIPTION OF THE DRAWINGS

The above and further features and advantages of the present invention will be clearer upon reading the detailed description of the preferred embodiments with reference to the accompanying drawings in which:

FIG. 1 schematically illustrates the logic arrangement of the maintenance system according to the present invention which is incorporated in a switch fabric;

FIG. 2 shows in more detail how the maintenance system of FIG. 1 works in a background maintenance mode;

FIG. 3 is a block flow showing the operation of the maintenance system of FIG. 1;

FIG. 4 is similar to FIG. 1 but schematically illustrates another embodiment of the maintenance system of the invention in which it is incorporated with redundant traffic channels.

### DETAILED DESCRIPTION OF THE PREFERRED EMBODIMENT

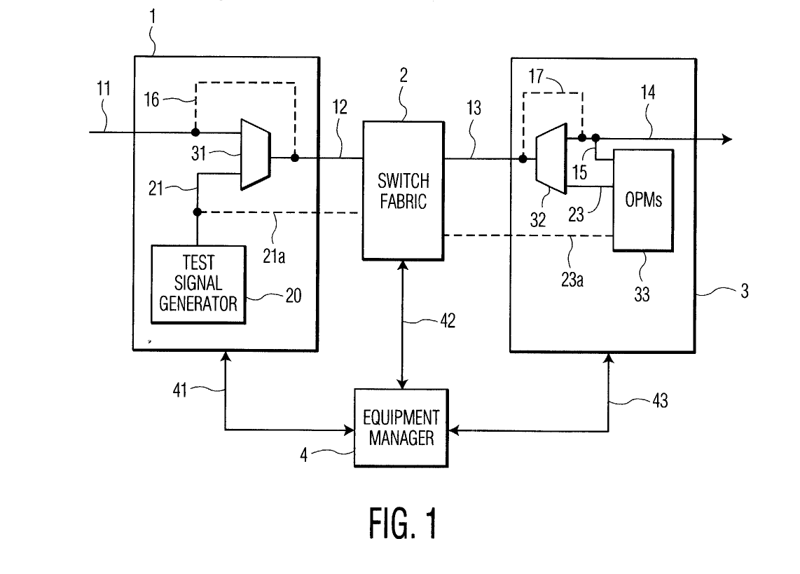

Reference is made to FIG. 1 in which a logical (but not necessarily physical) arrangement of the maintenance system of the invention is illustrated. The maintenance system of the invention mainly comprises an input module 1 and an output module 3 arranged before and after the switch fabric 2 respectively. In particular, the input module 1 receives an incoming traffic signal 11 from a previous node of the optical switching network and transmits it to the switch fabric 2 via an input traffic channel 12. The traffic signal is to be switched in the switch fabric 2 to a next node according to the address information carried in the incoming traffic signal as well as the routing table at the node having the switch fabric 2. The output module 3 receives the traffic signal via an output traffic channel 13 from the switch fabric 2 and transmits it further to the next destined node via traffic channel 14.

The switch fabric 2 used in this application shall be understood as broadly including any functional element in a node.

The input module 1 comprises a test signal generator 20 for generating a test signal which is sent to a multiplexer 31 to be multiplexed with the incoming traffic signal 11 so as to form a composite signal. The composite signal is sent to the switch fabric 2 via the input traffic channel 12, switched by the switch fabric 2 according to the address information carried by the incoming traffic signal 11, and then output from the switch fabric 2 to the output module 3 via the output traffic channel 13.

In the output module 3, the composite signal is demultiplexed by a demultiplexer 32 back into a traffic signal and a test signal. The traffic signal is further transmitted to its next destination node via a traffic channel 14, and the test signal is conveyed to quality measuring means implemented as, e.g., one or more optical performance monitors 33 which evaluate the quality of the demultiplexed test signal. The quality measuring means 33 also measures the quality of the demultiplexed traffic signal. In particular, a sample probe signal representing the demultiplexed traffic signal is extracted from the traffic channel 14 and sent to the quality measuring means 33 for quality evaluation.

The measurement results associated with the demultiplexed test signal and the traffic signal respectively are analyzed at the optical performance monitor 33 or are sent to the equipment manager 4 for analysis. The equipment manager 4 represents a high level managing center which may also controls the operations of the input 1, the switch fabric 2 as well as the output module 3, which may be implemented by software and hardware. The equipment manager 4 communicates with the input module 1, the switch fabric 2 and the output module 3 via electronic paths 41, 42, 43 respectively.

When the demultiplexed traffic signal is found to be defective, fault isolation is easy to achieve based upon an analysis of the available measurement results from the optical performance monitor 33. In particular, if only the demultiplexed traffic signal is found to be defective but the demultiplexed test signal is uncorrupted, it can be concluded that the incoming traffic signal was already bad before entering the switch fabric 2. If the demultiplexed test signal is also found to be defective, there should be an internal nodal fault within the switch fabric 2 which has compromised the incoming traffic signal. No complex algorithms are required in the present invention.

The above describes how the maintenance system in FIG. 1 operates to determine the fault cause for a live optical traffic signal. This is referred to as “real-time maintenance mode” in which the test signal is also transmitted via the traffic channel by being multiplexed with the live traffic signal, and thus the maintenance system is capable of checking whether there is an internal nodal fault in the switch fabric 2 by monitoring the test and traffic signals both transmitted over the same channel, i.e., the traffic optical channel 12, 13.

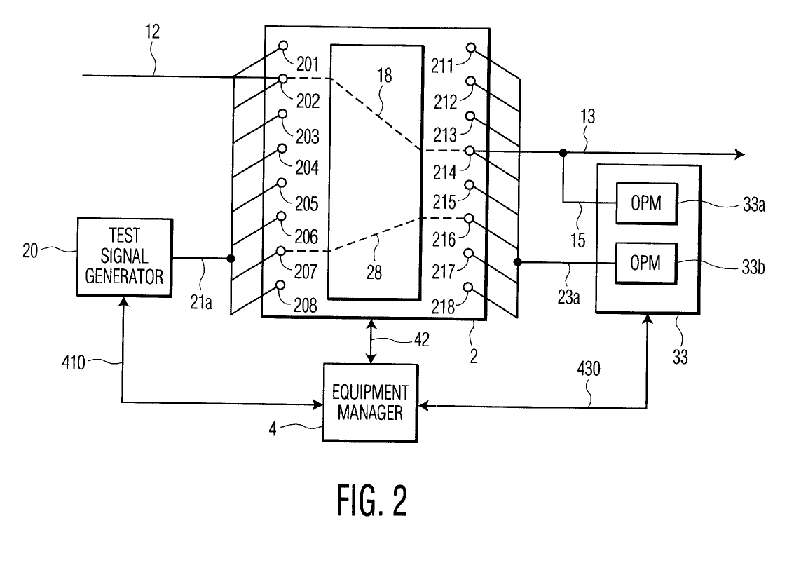

The maintenance system of the invention in FIG. 1 may also operate in a “background maintenance mode” in which the test signal is not transmitted through a live traffic channel, but through a selected unused channel of the switch fabric 2. This is explained in detail below with reference to FIGS. 1 and 2.

In the background maintenance mode, the test signal from the generator 20 is not multiplexed with the incoming traffic signal 11, but is transmitted directly to the switch fabric 2 via an input test channel 21a, shown in dotted line. Similarly, the incoming traffic signal 11 may bypass the multiplexer 31 via a bypass path 16 (shown in dotted line) and is transmitted directly into the switch fabric 2 via the input traffic channel 12. Coming out from the switch fabric 2 via an output test channel 23a (shown in dotted line), the test signal goes directly into the optical performance monitor 33b for evaluation. Similarly, the traffic signal leaves the switch fabric 2 via the output traffic channel 13, bypasses the multiplexer 32 via a bypass path 17 (shown in dotted line), and goes to its next destination node via traffic channel 14. A sample probe signal is extracted from the traffic channel 14 and sent to the optical performance monitor 33a via path 15. Thus, The quality measuring means 33 which comprise two separate optical performance monitors 33a and 33b measures the quality of both the traffic signal via the traffic channel and the test signal via the test channel.

Selection of the test channel in the background maintenance mode may be carried out dynamically in a predetermined priority scheme. At each background maintenance session, one of the input ports 201-208 and one of the output ports 211-218 of the switch fabric 2 are selected to form a test channel to be measured. For example, as shown in FIG. 2, the input port 207 and the output 216 are selected to form an internal test channel 28. Thus, a test channel is selected which comprises three portions, i.e., the input test channel 21a, the selected internal test channel 28 and the output test channel 23a. The measurement of the optical performance monitor 33 may determine whether the selected test channel (especially the internal test channel 28) works properly.

The ports of the test channel shall be selected among the unused ports that are not being used by a live traffic signal. For example, in FIG. 2, the incoming traffic signal 12 enters into the switch fabric 2 via input port 202, via an internal switching traffic path 18, and leaves from output port 214. Thus, ports 202 and 214 shall not be selected for the background maintenance mode because they are being used in transmitting the live traffic signal.

It is therefore appreciated that the maintenance system of the present invention may operate in the background maintenance mode when there is not a live optical traffic signal being transmitted through the switch fabric 2, or may select unused ports to form a test channel for background maintenance when there is a live optical traffic signal. Thus, by measuring the selected test channels, the switch fabric 2 may be optimally configured before carrying a live traffic signal.

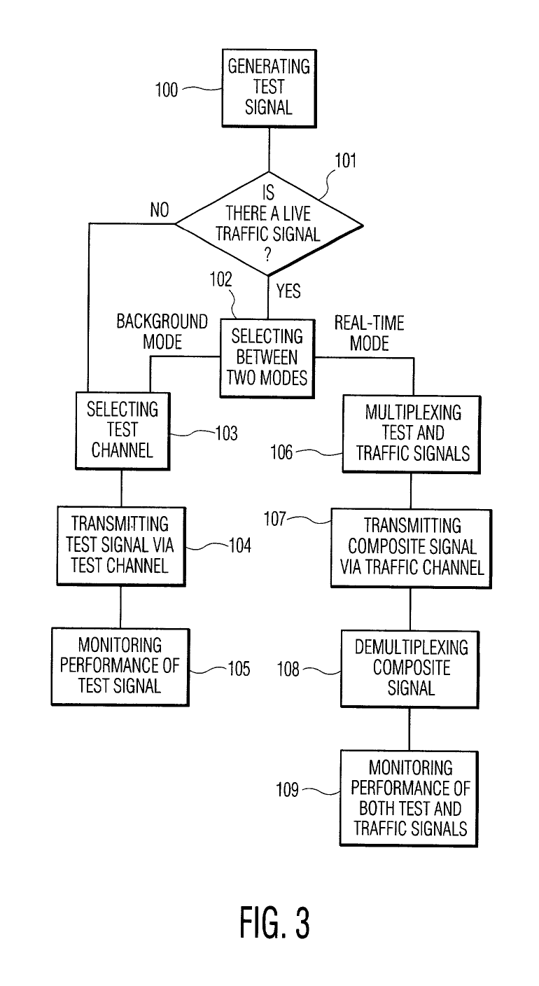

The operation of the maintenance system is illustrated in FIG. 3. The test signal is dynamically generated by the generator 20 at block 100. At block 101, if there is no live incoming traffic signal, the maintenance system always selects a background maintenance mode. If there is a live traffic mode, the maintenance system may select, at 102, between the background maintenance mode and real-time maintenance mode.

In the background maintenance mode, the test channel is selected by selecting unused input and output ports at block 103. At block 104, the test optical signal is transmitted through the switch fabric 2 to the optical performance monitor 33b via the selected test channel, and the quality of the test signal is measured by the monitor 33b at block 105 to determine whether the selected test channel works properly.

In the real-time maintenance mode, the test signal is multiplexed with the incoming traffic signal at block 106. Then the composite signal is transmitted through the switch fabric 2 via the traffic channel, as shown in block 107. After leaving the switch fabric 2, the composite signal is demultiplexed into the traffic signal and the test signal at block 108, and both the demultiplexed test signal and traffic signal are measured as to their quality by the optical performance monitors 33 at block 109.

The selection between the two modes at block 102 may be carried out according to a predetermined scheme. Preferably, the maintenance system can automatically shift between the real-time maintenance mode and the background maintenance mode. For example, as soon as the optical performance monitor 33a detects a fault of the traffic signal, the maintenance system immediately shifts from background maintenance mode to the real-time maintenance mode. When there is no traffic signal found to be defective, the maintenance system may shift back to the background maintenance mode to measure the selected test channels. Thus, the maintenance system may operate more effectively.

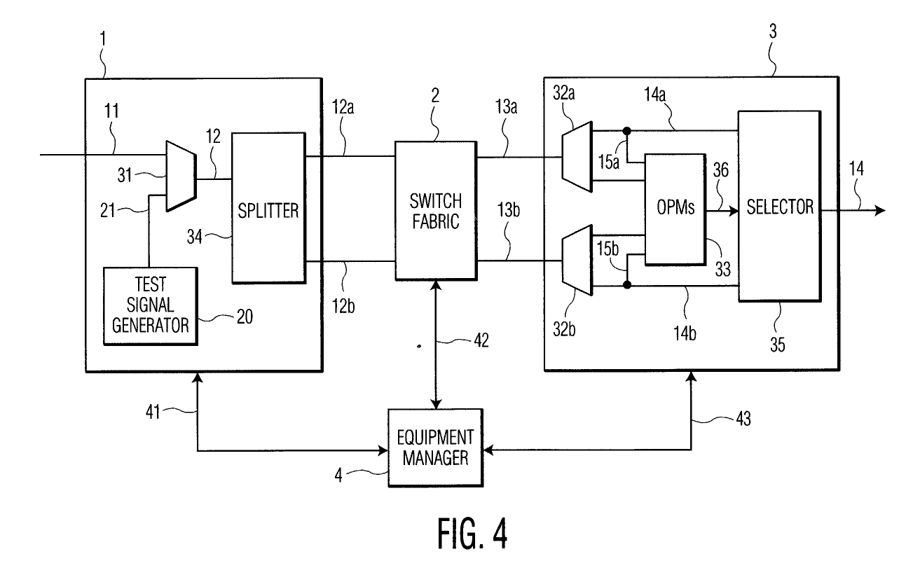

FIG. 4 shows an embodiment in which the maintenance system of the present invention is incorporated in an optical network switching system having a redundant traffic channels for reliability and availability considerations. The redundant traffic channel arrangement is disclosed in U.S. patent application Ser. No. 09/837,855 of the present assignee, the disclosure of which is incorporated here by reference.

As shown in FIG. 4, the multiplexed composite signal of the incoming optical traffic signal and the optical test signal is equally split into two divided composite signals by a splitter 34. The two divided composite signals are transmitted into the switch fabric 2 via separate input traffic channels 12a and 12b and leave the switch fabric 2 via separate output traffic channels 13a and 13b respectively. Each of the divided composite signals is then demultiplexed into a traffic signal and a test signal by the demultiplexers 32a and 32b respectively. The two demultiplexed traffic signals are further transmitted to a selector 35 via paths 14a and 14b respectively. The two demultiplexed test signals are transmitted to the quality measuring means or optical performance monitor or monitors 33 for performance evaluation. A sample probe signal is extracted from each of the demultiplexed traffic signals and is also sent, via optical paths 15a and 15b respectively, to the optical performance monitor 33 for performance evaluation.

The measurement and analysis results for the two demultiplexed traffic signals are provided to the selector 35 via electronic path 36. With the measurement and analysis results from the optical performance monitor 33, the selector 35 may determine which demultiplexed traffic signal is better. The selector 35 further transmits the better traffic signal to its next destination node while dropping the other one.

Furthermore, if a demultiplexed traffic signal is found to be defective, it can be determined, with the measurement and analysis acquired at the optical performance monitors, whether the problem was caused by the traffic channel via which it is transmitted through the switch fabric 2, or the traffic signal was already bad before it enters the switch fabric 2. As an alternative, analysis of the measurement results can be done at the equipment manager 4.

Although the above has described the preferred embodiments of the present invention, it shall be appreciated that numerous modifications and variations are obvious to a skilled person in the art without departing from the invention. For example, the bypass paths 16 and 17 may be implemented by a switching mechanism within the multiplexer 31 and the demultiplexer 32. The test signal may be generated on a periodic basis, or only be triggered when a defective traffic signal is found such as in the real-time maintenance mode. The selection between the two maintenance modes can be conducted manually or automatically. It shall also be understood that the arrangement shown in the drawings represent logical functionality, and not necessarily physical components. The quality measuring means 33 may be implemented as a single optical performance monitor even for measuring both traffic and test signals. Therefore, the scope of the invention is solely intent to be defined in the accompanying claims.

What is claimed is:

1. A maintenance system for an optical switch fabric in an optical network through which an optical traffic signal is conveyed via an optical traffic channel, said maintenance system comprises:
a generator for generating an optical test signal;
a multiplexer for optically multiplexing said test signal with said traffic signal to form a composite signal, said composite signal being conveyed through said switch fabric via said optical traffic channel;
a demultiplexer for optically demultiplexing said composite signal into said test signal and said traffic signal after it comes out from said switch fabric;
means for measuring quality of said test signal and said traffic signal output from said demultiplexer.

2. The maintenance system of claim 1 further comprises means for sending a sample probe signal representing said demultiplexed traffic signal to said quality measuring means.

3. The maintenance system of claim 1 further comprises means for receiving and analyzing said measured quality of said demultiplexed test and traffic signals so as to determine a fault source when said demultiplexed traffic signal is found to be defective.

4. The maintenance system of claim 1 further comprises means for further transmitting said demultiplexed traffic signal to its destination along said traffic signal channel.

5. The maintenance system of claim 1 further comprises means for dropping said demultiplexed test signal.

6. The maintenance system of claim 1 wherein said quality measuring means is one or more optical performance monitors.

7. The maintenance system of claim 1 wherein said generator generates said test signal only when there is a live optical traffic signal.

8. The maintenance system of claim 1 wherein said switching fabric conveys said composite signal according to addressing information of said traffic signal.

9. The maintenance system of claim 1 further comprises a splitter for splitting said multiplexed composite signal into two divided composite signals.

10. The maintenance system of claim 9 further comprising means for conveying said two divided composite signals through said switch fabric via two separate traffic signal channels.

11. The maintenance system of claim 9 wherein each of said two divided composite signals are demultiplexed, after leaving said switch fabric, into said divided traffic signal and test signal respectively.

12. The maintenance system of claim 11 further comprising a selector for selecting, in response to result from said quality measuring means, one of said two traffic signals to send to its destination.

13. The maintenance system of claim 1 further comprising means for dynamically selecting an input port and an output port of said switch fabric when there is no live optical traffic signal, forming an internal test channel of said switch fabric.

14. The maintenance system of claim 13 further comprising means for shifting said test signal to said multiplexer if there is a live traffic signal, and to said test channel if there is no live traffic signal.

15. A method of maintenance for an optical switch fabric in an optical network through which an optical traffic signal is conveyed via an optical traffic channel, comprising the steps of:
generating an optical test signal;
when there is an incoming optical traffic signal, optically multiplexing said test signal with said incoming traffic signal to form a composite signal;
conveying said composite signal via said optical traffic channel through said switch fabric;
optically demultiplexing said composite signal output from said switch fabric into said test signal and traffic signal; and
measuring quality of both said demultiplexed test signal and traffic signal.

16. The method of claim 15 wherein said measuring quality of said demultiplexed traffic signal is implemented by measuring a sample probe signal representing said demultiplexed traffic signal.

17. The method of claim 16 wherein said measuring comprises a step of extracting said sample probe signal from said demultiplexed traffic signal.

18. The method of claim 15 wherein said generating is carried out only when there is a live traffic signal.

19. The method of claim 15 further comprising a step of analyzing results of said measuring step so as to determine a possible fault source if said demultiplexed traffic signal is found to be defective.

20. The method of claim 15 further comprising a step of dropping said demultiplexed test signal and transmitting said demultiplexed traffic signal further to its destination along said traffic channel.

21. The method of claim 15 wherein said generating is implemented by a test signal generator.

22. The method of claim 15 wherein said measuring is implemented by one or more optical performance monitors.

23. The method of claim 15 further comprising a step of, when there is no incoming optical traffic signal, dynamically selecting an input port and an output port of said switch fabric to form an internal test channel.

24. The method of claim 23 further comprising steps of:
transmitting said test signal through said internal test channel when there is no incoming traffic signal; and
measuring quality of said test signal output from said switch fabric through said internal test channel so as to determine whether said internal test channel works properly.

25. A maintenance system for an optical switch fabric through which an optical traffic signal is transmitted via an optical traffic channel, said maintenance system comprises:
generator for generating a test signal;
means for selecting an input port and an output port of said switch fabric, forming an internal fabric test path to be measured;
means for transmitting said test signal through said test path; and
means for monitoring quality of said test signal after it comes out from said switch fabric through said test path so as to determine whether said test path works properly.

26. The maintenance system of claim 25 wherein said selected ports are unused ports when there are live signals being carried through said switch fabric.

27. The maintenance system of claim 25 wherein said generator generates said test signal dynamically.

28. The maintenance system of claim 27 wherein said generator generates said test signal on a periodical basis.

29. The maintenance system of claim 25 wherein said means for selecting selects said ports according to a predetermined priority scheme.

30. A method of maintenance for an optical switch fabric in an optical network, comprising the steps of:
generating a test signal;
selecting a test channel comprising an input port and an output port of said switch fabric;
transmitting said test signal through said test channel; and
measuring quality of said test signal outcome from said output port to monitor whether said test channel works properly.

31. A method of maintenance for an optical network switch fabric, comprising the steps of:
generating a test signal;
selecting between a real-time maintenance mode and a background maintenance mode;
in said real-time maintenance mode:
optically multiplexing said test signal with an incoming traffic signal being transmitted through a traffic channel to form a composite signal;
transmitting said composite signal over said traffic channel through said switch fabric;
optically demultiplexing said composite signal after it leaves said switch fabric into said test signal and said traffic signal;
measuring quality of both said demultiplexed test and traffic signals so as to monitor performance of said traffic channel;
in said background maintenance mode:
selecting a test channel comprising an input port and an output of said switch fabric;
transmitting said test signal via said test channel through said witch fabric; and
measuring quality of said test signal output from said switch fabric to monitor performance of said test channel.

32. The method of maintenance of claim 31 wherein said step of selecting between said two maintenance modes comprising a step of shifting between said two modes.

33. The method of maintenance of claim 31 wherein said real-time maintenance mode is selected when an optical traffic signal is found to be defective.

34. The method of maintenance of claim 31 wherein said real-time maintenance mode is always selected when there is a live optical traffic signal.

35. The method of maintenance of claim 31 wherein, in said background maintenance mode, said selected ports forming said test channel are not being used by any live traffic signal.

36. An optical network switching system comprising:
a switch fabric for conveying an incoming optical traffic signal to its destined output of said switching system via a traffic channel;
an input module for receiving said incoming optical traffic signal and forwarding it to said switch fabric;
an output module for receiving said optical traffic output from said switch fabric and forwarding it to said output destination of said switching system;
wherein said input module comprises:
a generator for generating a test signal;
means for multiplexing said test signal with said incoming traffic signal to form a composite optical signal which is transmitted to said switch fabric via said traffic channel;
wherein said output module comprises:
means for demultiplexing said composite optical signal conveyed by said switch fabric into said test signal and traffic signal; and
means for measuring quality of both said demultiplexed test signal and traffic signal.

37. The system of claim 36 wherein said input module further comprises a splitter for splitting said composite signal into two divided composite signals and forwarding them to said switch fabric via two separate traffic channels.

38. The system of claim 37 wherein said demultiplexing means in said output module is capable of receiving said two divided composite signals via said two separate traffic channels and demultiplexing each of said two composite signal into said test signal and traffic signal respectively.

39. The system of claim 38 wherein said output module further comprises means for sending a sample probe signal from each said demultiplexed traffic signals to said quality measuring means.

40. The system of claim 39 wherein said output module further comprises means for sending said two demultiplexed test signals to said quality measuring means.

41. The system of claim 38 wherein said output module further comprises a selector for receiving said two demultiplexed traffic signals as well as measurement results associated with said two demultiplexed traffic signals from said quality measuring means, and for selecting one of said two demultiplexed traffic signals to send to said output destination in according to said measurement results.

42. The system of claim 41 wherein said selector also receives said two demultiplexed test signals for analyzing performance of said two traffic channels.
